(19) United States
(12) Patent Application Publication
(10) Pub. No.: US 2026/0100140 A1
(43) Pub. Date: Apr. 9, 2026

(54) Artificial Intelligence-based Exam Question Generating Method and System

(71) Applicant: ViewSonic International Corporation, New Taipei City (TW)

(72) Inventors: Hsin-Yu Lin, New Taipei City (TW); I-Hsin Chen, New Taipei City (TW); Yu-Ming Lu, New Taipei City (TW); Kevin-Kuo Chu, New Taipei City (TW); Yun-Cheng Hsin, New Taipei City (TW); Shun-Ta Wang, New Taipei City (TW); Chin-Shou Lin, New Taipei City (TW); Wang-Fat Ho, New Taipei City (TW)

(73) Assignee: ViewSonic International Corporation, New Taipei City (TW)

(21) Appl. No.: 19/071,785

(22) Filed: Mar. 6, 2025

(30) Foreign Application Priority Data
Oct. 8, 2024 (TW) 113138283

(51) Int. Cl. G09B 7/00; G06N 5/02

(52) U.S. Cl. CPC G09B 7/00; G06N 5/027

(57) ABSTRACT

An exam question generating method, based on artificial intelligence (AI), includes receiving at least one reference material input by a user; receiving at least one exam parameter input by the user; and generating a plurality of exam question rules through an AI model, and generating at least one exam question that complies with the plurality of exam question rules based on the at least one reference material and the at least one exam parameter; wherein the AI model has undergone a pre-training process, and the pre-training process includes setting at least one educational material as a training dataset; and analyzing the training dataset to induce the plurality of exam question rules.

### BACKGROUND OF THE INVENTION

### 1. Field of the Invention

The present invention relates to an artificial intelligence-based exam question generating method and system, and more particularly, to an artificial intelligence-based exam question generating method and system to provide high-quality, highly relevant to exam questions that comply with educational theories and regulations.

### 2. Description of the Prior Art

In the field of education, timely assessments serve as crucial indicators for educators to evaluate learning outcomes, the generation of exam questions is an important and challenging task. Traditionally, this work is done manually by educators, which heavily depends on educators' personal experience, knowledge capabilities, and professional judgment. This is a time-consuming and labor-intensive process that may even divert educators' attention from other important teaching responsibilities. Furthermore, as educational concepts and curriculum content continuously evolve, manually generating exam questions may struggle to keep pace, leading to test content that falls behind the latest educational trends and requirements. Additionally, in large-scale educational environments, manual exam question creation makes it difficult to develop customized exam questions for each student or class, limiting educational flexibility and specificity. Moreover, manual exam question creation inevitably reflects the exam question creators' personal preferences and potential biases, which may lead to unfair or imbalanced exam questions in certain aspects.

Therefore, one of the goals in the field is to provide high-quality, highly relevant exam questions that align with educational theories and regulations while significantly reducing the consumption of human resources.

### SUMMARY OF THE INVENTION

Therefore, the present invention is to provide an AI-based exam question generating method and system capable of providing high-quality, highly relevant exam questions that comply with educational theories and regulations.

An embodiment of the present invention discloses an exam question generating method, based on artificial intelligence (AI), which comprises receiving at least one reference material input by a user; receiving at least one exam parameter input by the user; and generating a plurality of exam question rules through an AI model, and generating at least one exam question that complies with the plurality of exam question rules based on the at least one reference material and the at least one exam parameter; wherein the AI model has undergone a pre-training process, and the pre-training process comprises setting at least one educational material as a training dataset; and analyzing the training dataset to induce the plurality of exam question rules.

Another embodiment of the present invention discloses an exam question generating system, based on artificial intelligence (AI), which comprises a data input module, configured to receive at least one reference material input by a user; a parameter selection module, configured to receive at least one exam parameter input by the user; and an AI model, coupled with the data input module and the parameter selection module, configured to generate a plurality of exam question rules, and generate at least one exam question that complies with the plurality of exam question rules based on the at least one reference material and the at least one exam parameter; wherein the AI model has undergone a pre-training process, and the pre-training process comprises setting at least one educational material as a training dataset; and analyzing the training dataset to induce the plurality of exam question rules.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of an AI-based exam question generating process according to an embodiment of the present invention.

FIG. 2 illustrates a schematic diagram of a pre-training process according to an embodiment of the present invention.

FIG. 3 illustrates a schematic diagram of an exam question generating system according to an embodiment of the present invention.

FIG. 4 illustrates a schematic diagram of an exam question generating system according to an embodiment of the present invention.

FIG. 5 illustrates a schematic diagram of an operation screen according to an embodiment of the present invention.

### DETAILED DESCRIPTION

With the development of Artificial Intelligence (AI) technology, AI-based Large Language Models (LLMs) can engage in natural language dialogue with humans. Generally, a user may input text prompts to make the LLMs respond or generate content that meets the user's requirements. In this context, educators may use LLMs to generate exam questions. However, the AI or LLM-based exam question generating technologies of the prior art have several limitations and cannot fully meet the needs of educators and learners.

Specifically, when a user inputs text prompts to request LLMs to generate exam questions, the effectiveness or reliability depends on the accuracy of the text prompts, and different LLMs may interpret the same text prompts differently. If a user lacks professional knowledge in providing effective text prompts, this may result in inconsistent quality of generated exam questions. Moreover, since LLMs generate exam questions based only on limited information provided by users, the resulting exam questions often do not match the user's actual needs; for example, the generated exam questions may not be suitable for specific grade levels or may not align with the expected learning objectives. Additionally, the exam question generation technologies of the prior art lack a deep understanding of educational theory and practice, which may result in generated exam questions that may not align with recognized educational standards, such as Bloom's taxonomy adopted by the U.S. education sector or the 12-Year Basic Education Curriculum Guidelines and Implementation Regulations adopted by Taiwan's education community.

Furthermore, LLMs typically predict response content based on large amounts of public data and context following user prompts, and current LLMs may fabricate incorrect facts, a phenomenon known as “Hallucination.” In this situation, the prior art exam question generating technologies face difficulties in understanding and utilizing complex educational contexts, which may lead to generated exam questions that are disconnected from given topics or learning materials, or even result in completely irrelevant situations where the generated exam questions are entirely unrelated to the expected topics or content, or contain factual errors, logical fallacies, or inappropriate difficulty levels, requiring educators to conduct extensive manual review and modification, requiring educators to perform extensive manual review and modifications.

In view of the limitations of existing AI-assisted exam question generating technologies, the present invention aims to provide an efficient, advanced, and intelligent exam question generating system that can combine the efficiency of artificial intelligence with educational expertise, comprehensively utilize various educational resources, deeply understand educational theory and practice, and generate high-quality, highly relevant exam questions while significantly reducing human resource consumption.

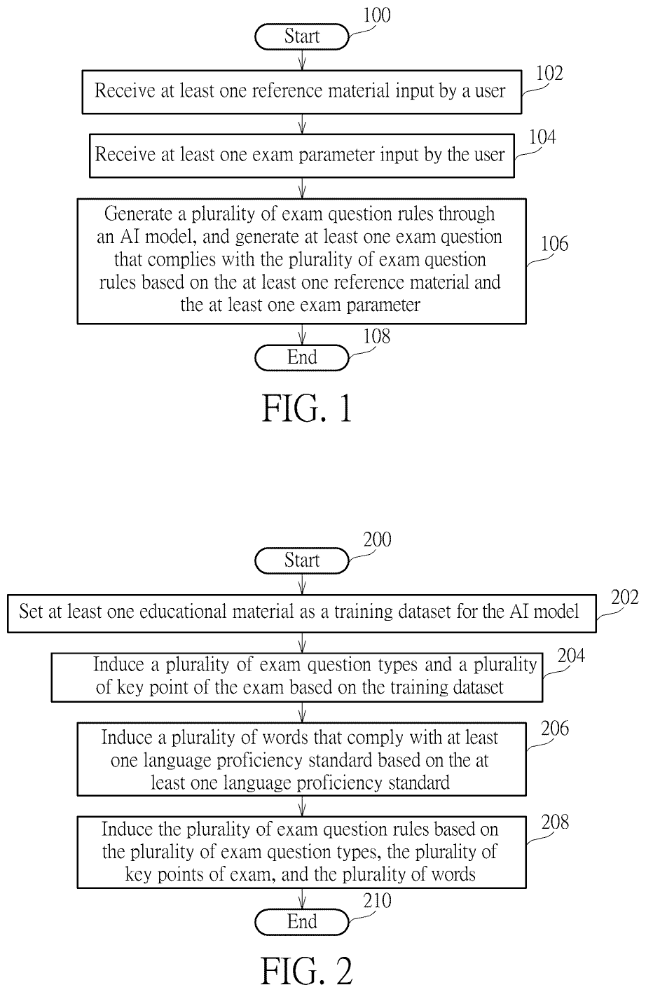

Specifically, referring to FIG. 1, which illustrates a schematic diagram of an AI-based exam question generating process 1 according to an embodiment of the present invention. The exam question generating process 1 includes the following steps:

Step 100: Start.

Step 102: Receive at least one reference material input by a user.

Step 104: Receive at least one exam parameter input by the user.

Step 106: Generate a plurality of exam question rules through an AI model, and generate at least one exam question that complies with the plurality of exam question rules based on the at least one reference material and the at least one exam parameter.

### Step 108: End.

According to the exam question generating process 1, when generating exam questions, a user may input relevant reference materials and exam parameters (Steps 102, 104). Before generating exam questions, the embodiment of the present invention has already pre-generated a plurality of exam question rules through an AI model. When the reference materials and exam parameters input by the user are received, then the AI model generates at least one exam question that complies with the exam question rules (Step 106). In short, the embodiment of the present invention pre-trains the AI model to generate exam question rules, and upon receiving the reference materials and exam parameters from the user, generates exam questions that comply with the pre-generated exam question rules. As a result, the exam questions generated by the AI model are not only based on user-provided information but may also comply with pre-generated exam question rules, avoiding the fabrication of incorrect facts by the AI model, ensuring high-quality, highly relevant exam questions while significantly reducing human resource consumption. The AI model adopted in the embodiment of the present invention is preferably an LLM.

Specifically, in one embodiment, the user-input reference materials may be one or more of images, videos, audio, text documents, webpage links, and are not limited to these; while the exam parameters may include one or more of a subject domain, an exam question type, a learning objective or a learning checkpoint, an educational level, and a language proficiency level, and are not limited to these. In other words, when generating the exam questions, the user inputs the reference materials related to the desired exam questions into the AI model of the embodiment and selects appropriate exam parameters to enable the AI model to generate the exam questions that align with the topic or learning materials. It should be noted that the above-mentioned user-input reference materials and exam parameters are only examples applicable to the embodiment of the present invention, and those skilled in the art may make appropriate modification according to actual application scope and system or user requirements. For example, images may be photographs, screenshots, or other static images like “.jpg”, “.png”, “.gif” files, videos may be dynamic audio-visual files like “.mp4”, “.avi” files, and text documents may be “.txt”, “.doc”, “.pdf” files, and not limited thereto. Subject domains may include mathematics, language, science, etc., exam question types may include true/false, single-choice, multiple-choice, fill-in-the-blank, essay exam questions, etc., and learning objectives or learning checkpoints may target specific topics, subjects, lessons, etc., and not limited thereto. Additionally, educational levels may include target grades, educational classifications, difficulty levels, etc., and should be adjusted according to different educational systems. For instance, the U.S. education system widely adopts Bloom's taxonomy as its educational theory, so when applied to the U.S. education field, exam question classification levels should be determined according to Bloom's taxonomy. Conversely, when applied to Taiwan's education field, classification levels may be determined according to 12-Year Basic Education Curriculum Guidelines and Implementation Regulations of Taiwanese Ministry of Education. Standards of language proficiency levels are related to the applied language; for example, when applied to English exam questions, the language proficiency level standards may reference the Common European Framework of Reference for Languages (CEFR), Lexile Framework, Accelerated Reader system, Guided Reading Level system, or Developmental Reading Assessment levels, not limited to these. When applied to Chinese exam questions, language proficiency level standards may reference the Diagnostic Assessment of Chinese Competence system, etc., not limited to these.

As mentioned above, before generating the exam questions, the AI model of the embodiment of the present invention has undergone a pre-training process to generate the exam question rules. To ensure the AI model generates highly relevant exam questions, the pre-training process may include setting at least one educational material as a training dataset for the AI model, allowing the AI model to analyze the training dataset to induce the exam question rules. The educational material may be selected from one or more of at least one educational theory, at least one language proficiency standard, at least one textbook, a plurality of exam questions, and open-source materials. The educational theory may be adjusted according to different application areas; for example, for U.S. education, it may be Bloom's taxonomy, while for Taiwan's education, it may be the 12-Year Basic Education Curriculum Guidelines and Implementation Regulations. Similarly, language proficiency standards are also related to the application area. For English exam questions, language proficiency level standards may reference the Common European Framework of Reference for Languages, Lexile Framework, Accelerated Reader system, Guided Reading Level system, Developmental Reading Assessment levels, etc., not limited to these. For Chinese exam questions, language proficiency level standards may reference the Diagnostic Assessment of Chinese Competence system, etc., not limited to these. After obtaining an appropriate training dataset, the AI model may accordingly induce exam question types and key points of the exam, and based on language proficiency standards, derive words that comply with these standards, thereby deriving exam question rules.

The above pre-training process for the AI model can be summarized as a pre-training process 2, as shown in FIG. 2. The pre-training process 2 includes the following steps:

Step 200: Start.

Step 202: Set at least one educational material as a training dataset for the AI model.

Step 204: Induce a plurality of exam question types and a plurality of key point of the exam based on the training dataset.

Step 206: Induce a plurality of words that comply with at least one language proficiency standard based on the at least one language proficiency standard.

Step 208: Induce the plurality of exam question rules based on the plurality of exam question types, the plurality of key points of exam, and the plurality of words.

Step 210: End.

Detailed explanations of the pre-training process 2 may refer to the above, where Steps 204-208 detail the analysis of the training dataset to derive exam question rules. Additionally, the pre-training process 2 may further continuously adjust and improve the model based on new data or feedback, such as optimizing the AI model repeatedly based on new training datasets (such as updated educational theories, subject materials, etc.) or user feedback on exam question quality (such as relevance).

After the pre-training process 2, the AI model may generate exam questions that meet user requirements based on exam question rules, and use words that comply with the set language proficiency standards. For example, if a user wants to generate exam questions about the life of Abraham Lincoln, the 16^{th} President of the United States, the embodiment of the present invention may use appropriate wording for different audiences on the same topic. For instance, for U.S. middle school students, the exam question may be:

### (Exam Question 1) “Exam Question: What was Abraham Lincoln's Primary Goal During the American Civil War?

A. To abolish slavery
B. To win independence from Britain
C. To maintain the Union
D. To expand U.S. territory”

While for U.S. elementary school students, an exam question on the same topic would be:

### (Exam Question 2) “Exam Question: What did Abraham Lincoln Want to Achieve During the American Civil War?

A. To end slavery
B. To become free from Britain
C. To keep the country together
D. To make the country bigger”

Comparing Exam questions 1 and 2, it can be seen that for different audiences (U.S. middle school and elementary school students), the embodiment of the present invention generates exam questions that are more accurate and reasonable in content and form, and match the test-takers' knowledge levels.

After the AI model generates exam questions, the embodiment of the present invention further outputs the exam questions, and the output format thereof is not limited to specific types, which may be one or more of text, images, audio, video, and interactive interfaces.

Thus, through the exam question generating process 1 and the pre-training process 2, the embodiment of the present invention combines advanced LLM technology with educational theory to generate high-quality, highly relevant exam questions. As a result, the embodiment of the present invention can significantly reduce the time and effort the educators spend on creating exam questions and can quickly generate high-quality exam questions for different audiences, meeting various scales of educational needs. Moreover, since the present invention uses educational material as a training dataset, after deep learning and large-scale pre-training, the generated exam questions are more accurate and reasonable in content and form, complying with the latest educational theories or knowledge. This ensures exam question consistency, appropriateness, and unbiasedness, and can generate customized exam questions based on specific educational needs, learning objectives, and test-takers, thus flexibly adapting to requirements of different subjects, grades, and educational standards. Furthermore, through appropriate adjustment of the educational material, the embodiment of the present invention may easily apply to educational work in different languages, meeting international education and language learning needs, and may be continuously improved through learning from the latest educational resources and feedback, ensuring exam questions always reflect the latest educational trends and knowledge development.

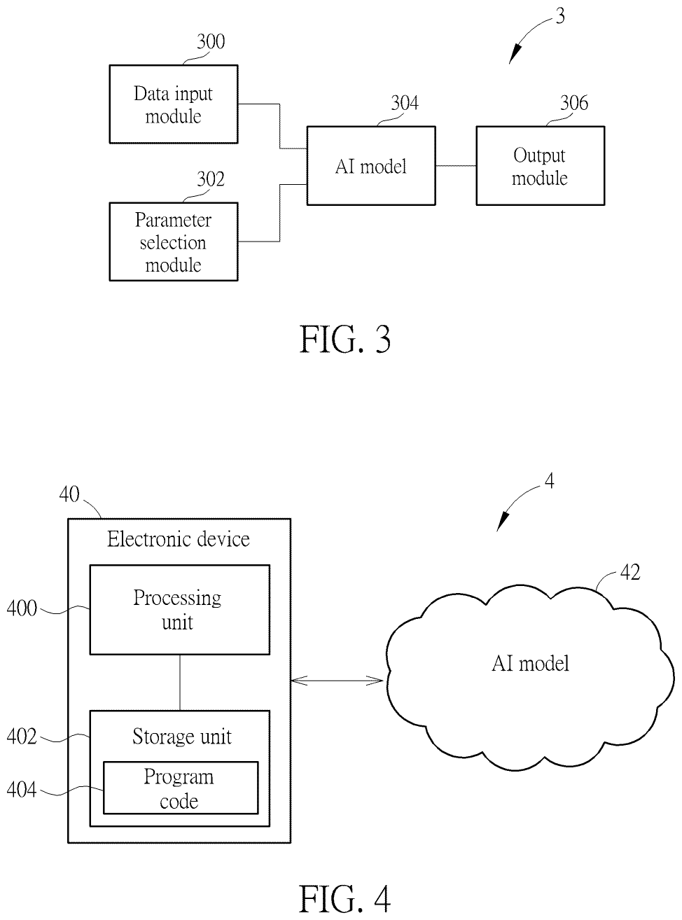

Therefore, the present invention is able to generate high-quality, highly relevant exam questions to improve the efficiency and quality of educational assessment. It should be noted that the exam question generating process 1 and the pre-training process 2 are operational methods for using and training the AI model to generate exam questions, and their implementation methods may be adjusted according to different systems. For example, referring to FIG. 3, which is a schematic diagram of an exam question generating system 3 according to an embodiment of the present invention. The exam question generating system 3 may implement or execute the exam question generating process 1 and the pre-training process 2 of the embodiment of the present invention, and includes a data input module 300, a parameter selection module 302, an AI model 304, and an output module 306. The data input module 300 may receive at least one reference material input by a user, while the parameter selection module 302 may receive at least one exam parameter input by the user. The AI model 304 is coupled to the data input module 300 and the parameter selection module 302, and may execute the pre-training process 2 to generate a plurality of exam question rules, and generate exam questions that comply with the exam question rules based on reference materials and exam parameters. The output module 306 is coupled to the AI model 304 and outputs exam questions in specific formats. The exam question generating system 3 explains possible system architecture for implementing the exam question generating process 1 and the pre-training process 2 in functional blocks. The implementation of the exam question generating process 1, the pre-training process 2, and their derived operational variations should be well-known skills in the field, and are not elaborated further. Additionally, although the exam question generating system 3 represents the system architecture implementing the exam question generating process 1 in functional blocks, those skilled in the art should understand that each functional block may be part of program code, software, hardware, or their composite composition.

For example, continuing to refer to FIG. 4, which shows a schematic diagram of an exam question generating system 4 according to an embodiment of the present invention. The exam question generating system 4 is derived from the exam question generating system 3 and may implement or execute the exam question generating process 1 and the pre-training process 2 of the embodiment of the present invention. The exam question generating system 4 includes an electronic device 40 and an AI model 42. The AI model 42 may be any LLM capable of performing natural language dialogue, but is not limited thereto. The electronic device 40 may be a personal computer, tablet computer, laptop computer, mobile phone, etc., and generally includes a processing unit 400 and a storage unit 402. The processing unit 400 may be a general processor, microprocessor, Application Specific Integrated Circuit (ASIC), etc., or a combination thereof. The storage unit 402 is coupled to the processing unit 400 and may be any data storage device used to store program code 404, which is read and executed through the processing unit 400. For example, the storage unit 402 may be Read-Only Memory (ROM), flash memory, Random Access Memory (RAM), hard drive, optical data storage device, and non-volatile storage unit, but is not limited to these. Additionally, the electronic device 40 may include wired or wireless communication ports for data exchange with the AI model 42 through wired or wireless means. According to the exam question generating process 1, the electronic device 40 may receive reference materials and exam parameters input by a user and transmit them to the AI model 42 through wired or wireless means. Before generating exam questions, the AI model 42 has already undergone the pre-training process 2, to set educational material as a training dataset and analyze the training dataset to derive exam question rules. Therefore, when receiving the reference materials and exam parameters transmitted from the electronic device 40, the AI model 42 can accordingly generate exam questions that comply with the exam question rules and send them back to the electronic device 40. In other words, in the exam question generating system 4, the electronic device 40 can perform the functions of the data input module 300, the parameter selection module 302, and the output module 306 of the exam question generating system 3. The implementation of the exam question generating process 1, the pre-training process 2, and their derived operational variations should be well-known skills in the field, and will not be elaborated further.

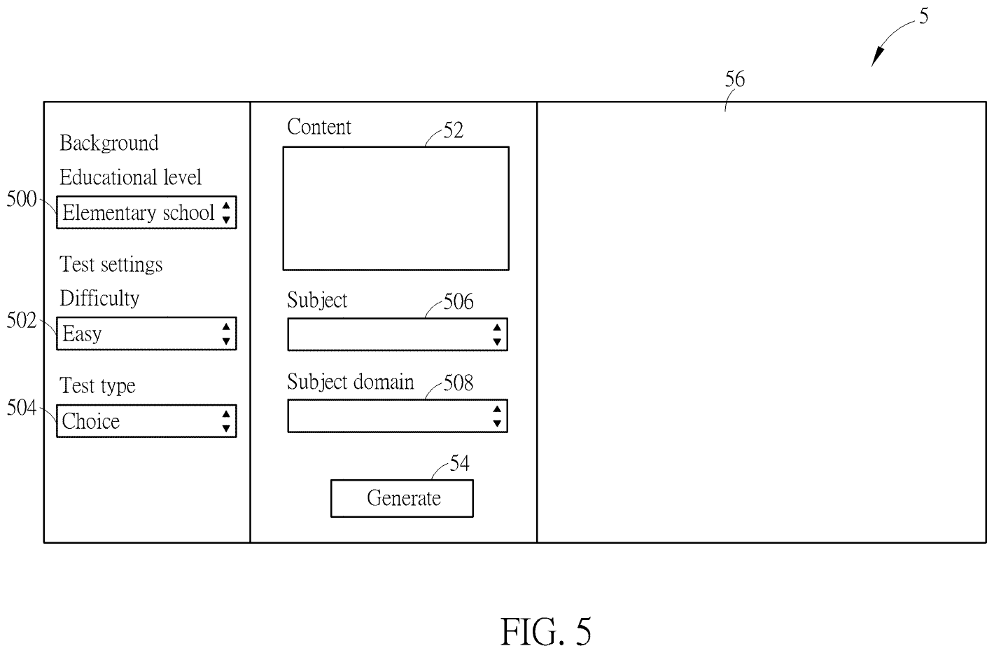

Specifically, referring to FIG. 5, which shows a schematic diagram of an operation screen 5 according to an embodiment of the present invention. The operation screen 5 may a screen where a user operates the exam question generating system 3 or 4 to generate exam questions, and may be displayed on a computer screen, mobile phone screen, etc., but is not limited to these. The operation screen 5 includes parameter options 500-508, a reference material field 52, an exam question generating button 54, and an exam question output field 56. A user may input reference materials into the reference material field 52, for example, through drag and drop, adding files, uploading, etc., then select exam parameters through the parameter options 500-508, such as determining background educational level, difficulty, question types, subject, subject domain, learning objective or learning checkpoints, and language proficiency level, but not limited to these. Then, the user may click the exam question generating button 54, and the exam question generating system 3 or 4 can generate exam questions accordingly and display the exam question generating results in the exam question output field 56. It should be noted that the operation screen 5 is a schematic illustration of user operation, and those skilled in the art should make appropriate adjustments according to actual needs. For example, the parameter options 500-508 used to receive the exam parameters input by the user may be appropriately increased or decreased. For instance, in one embodiment, options may be added or modified to select the grade level corresponding to the test taker; in another embodiment, if used in the US education system, options may be added or modified to select specific state education systems, and Bloom's taxonomy classification levels may also be added. In yet another embodiment, options may be added or modified to select the format of generated exam questions, such as one or more of text, images, audio, video, and interactive interfaces. After generating the exam questions, control buttons for outputting the exam questions may also be added, such as email and print buttons. Such additions or modifications of options to control the exam question generation methods of the exam question generating system 3 or 4 should be well-known to those skilled in the art and thus will not be elaborated further.

In the prior art, exam question generation mainly relies on manual creation, which heavily depends on educators' personal experience, knowledge capabilities, and professional judgment. It is a time-consuming and labor-intensive process that may even divert educators' attention from other important teaching tasks. In recent years, although AI-based LLMs can generate content that meets user needs based on user-input text prompts, they only generate exam questions based on limited information provided by users and lack deep understanding of educational theory and practice, resulting in generated exam questions that cannot meet actual needs. In comparison, the present invention combines the efficiency of AI and professional knowledge of education, comprehensively utilizes various educational resources, deeply understands educational theory and practice, and generates high-quality, highly relevant exam questions, which can significantly reduce human resource consumption and meet educational needs of different scales.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An exam question generating method, based on artificial intelligence (AI), comprising:
receiving at least one reference material input by a user;
receiving at least one exam parameter input by the user; and
generating a plurality of exam question rules through an AI model, and generating at least one exam question that complies with the plurality of exam question rules based on the at least one reference material and the at least one exam parameter;
wherein the AI model has undergone a pre-training process, and the pre-training process comprises:
setting at least one educational material as a training dataset; and
analyzing the training dataset to induce the plurality of exam question rules.

2. The exam question generating method of claim 1, wherein the at least one reference material is selected from one or more of an image, a video, an audio file, a text document, and a webpage link.

3. The exam question generating method of claim 1, wherein the at least one exam parameter is selected from one or more of a subject domain, an exam question type, a learning objective or a learning checkpoint, an educational level, and a language proficiency level.

4. The exam question generating method of claim 1, wherein the at least one educational material is selected from one or more of at least one educational theory, at least one language proficiency standard, at least one textbook, a plurality of exam questions, and open-source materials.

5. The exam question generating method of claim 4, wherein the at least one educational theory is selected from one or more of Bloom's taxonomy or the 12-Year Basic Education Curriculum Guidelines and Implementation Regulations, and the at least one language proficiency standard is selected from one or more of Lexile Framework and Common European Framework of Reference for Languages.

6. The exam question generating method of claim 1, wherein the step of analyzing the training dataset to induce the plurality of exam question rules in the pre-training process comprises:
inducing a plurality of exam question types and a plurality of key points of exam based on the training dataset;
inducing a plurality of words that comply with at least one language proficiency standard based on the at least one language proficiency standard; and
inducing the plurality of exam question rules based on the plurality of exam question types, the plurality of key points of exam, and the plurality of words.

7. The exam question generating method of claim 6, wherein the AI model uses the plurality of words that comply with the at least one language proficiency standard to generate the at least one exam question.

8. The exam question generating method of claim 6, wherein the at least one language proficiency standard is selected from one or more of Lexile Framework and Common European Framework of Reference for Languages.

9. The exam question generating method of claim 1, further comprising outputting the at least one exam question in a format.

10. The exam question generating method of claim 9, wherein the format is selected from one or more of text, image, audio, video, and interactive interface.

11. An exam question generating system, based on artificial intelligence (AI), comprising:
a data input module, configured to receive at least one reference material input by a user;
a parameter selection module, configured to receive at least one exam parameter input by the user; and
an AI model, coupled to the data input module and the parameter selection module, configured to generate a plurality of exam question rules, and generate at least one exam question that complies with the plurality of exam question rules based on the at least one reference material and the at least one exam parameter;
wherein the AI model has undergone a pre-training process, and the pre-training process comprises:
setting at least one educational material as a training dataset; and
analyzing the training dataset to induce the plurality of exam question rules.

12. The exam question generating system of claim 11, wherein the at least one reference material is selected from one or more of an image, a video, an audio file, a text document, and a webpage link.

13. The exam question generating system of claim 11, wherein the at least one exam parameter is selected from one or more of a subject domain, an exam question type, a learning objective or a learning checkpoint, an educational level, and a language proficiency level.

14. The exam question generating system of claim 11, wherein the at least one educational material is selected from one or more of at least one educational theory, at least one language proficiency standard, at least one textbook, a plurality of exam questions, and open-source materials.

15. The exam question generating system of claim 14, wherein the at least one educational theory is selected from one or more of Bloom's taxonomy or the 12-Year Basic Education Curriculum Guidelines and Implementation Regulations, and the at least one language proficiency standard is selected from one or more of Lexile Framework and Common European Framework of Reference for Languages.

16. The exam question generating system of claim 11, wherein the step of analyzing the training dataset to induce the plurality of exam question rules in the pre-training process comprises:
inducing a plurality of exam question types and a plurality of key points of exam based on the training dataset;
inducing a plurality of words that comply with at least one language proficiency standard based on the at least one language proficiency standard; and
inducing the plurality of exam question rules based on the plurality of exam question types, the plurality of key points of exam, and the plurality of words.

17. The exam question generating system of claim 16, wherein the AI model uses the plurality of words that comply with the at least one language proficiency standard to generate the at least one exam question.

18. The exam question generating system of claim 16, wherein the at least one language proficiency standard is selected from one or more of Lexile Framework and Common European Framework of Reference for Languages.

19. The exam question generating system of claim 11, further comprising an output module, coupled to the AI model, configured to output the at least one exam question in a format.

20. The exam question generating system of claim 19, wherein the format is selected from one or more of text, image, audio, video, and interactive interface.
